(19) United States
(12) Patent Application Publication
(10) Pub. No.: US 2025/0349199 A1
(43) Pub. Date: Nov. 13, 2025

(54) LOCATOR DEVICE FOR KEYS

(71) Applicant: Timothy Brown, New Orleans, LA (US)

(72) Inventor: Timothy Brown, New Orleans, LA (US)

(21) Appl. No.: 18/658,271

(22) Filed: May 8, 2024

(51) Int. Cl. G08B 21/24

(52) U.S. Cl. CPC G08B 21/24

(57) ABSTRACT

A locator device for alternately locating keys and a mobile computing device includes a housing which houses a processor, a transceiver, and a Global Positioning System (GPS) module. The processor is operatively couped to the transceiver and the GPS module. The processor is configured to communicate wirelessly with a mobile computing device via the transceiver. The GPS module is configured to determine location data for the locator device, and the processor is programmed to transmit the location data to the mobile computing device upon receiving a location request signal from the mobile computing device. The location data may be shown by the mobile computing device in the form of an indicator icon on a map and a route which directs a user to the locator device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to locator devices and more particularly pertains to a new locator device for alternately locating keys and a mobile computing device.

### (2) Description of Related Art Including Information Disclosed Under 37 CFR 1.97 and 1.98

The prior art relates to locator devices for finding keys, mobile phones, or the like. The prior art fails to disclose such a device which is attachable to a key or a keyring and which is locatable either by using a mobile phone to emit an alarm from the locator device or generating directions to the locator device.

### BRIEF SUMMARY OF THE INVENTION

An embodiment of the disclosure meets the needs presented above by generally comprising a housing which houses a processor, a transceiver, and a Global Positioning System (GPS) module. The processor is operatively couped to the transceiver and the GPS module. The processor is configured to communicate wirelessly with a mobile computing device via the transceiver. The GPS module is configured to determine location data for the locator device, and the processor is programmed to transmit the location data to the mobile computing device upon receiving a location request signal from the mobile computing device. The location data may be shown by the mobile computing device in the form of an indicator icon on a map and a route which directs a user to the locator device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a locator device according to an embodiment of the disclosure.

FIG. 2 is a rear view of an embodiment of the disclosure.

FIG. 3 is a block diagram of an embodiment of the disclosure.

FIG. 4 is an in-use view of an embodiment of the disclosure.

### DETAILED DESCRIPTION OF THE INVENTION

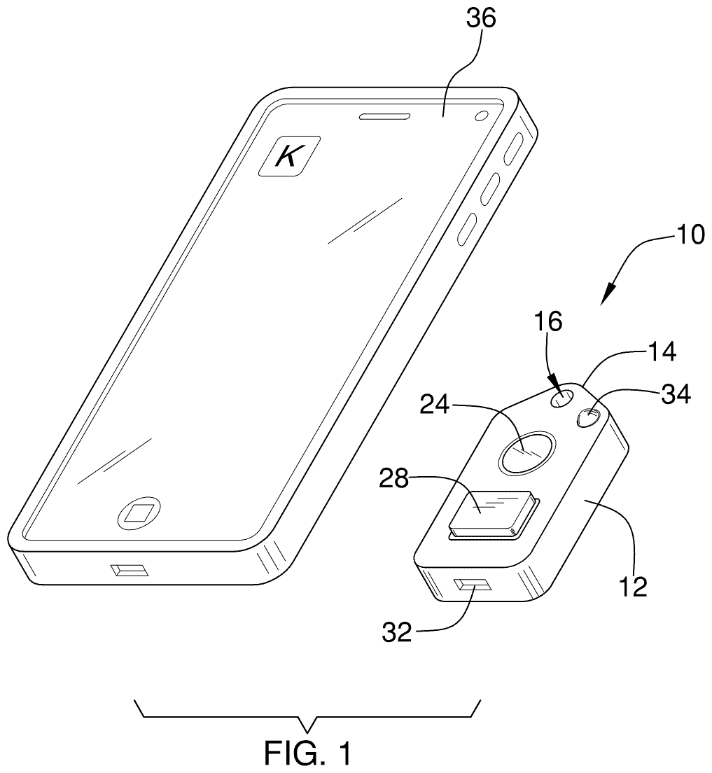

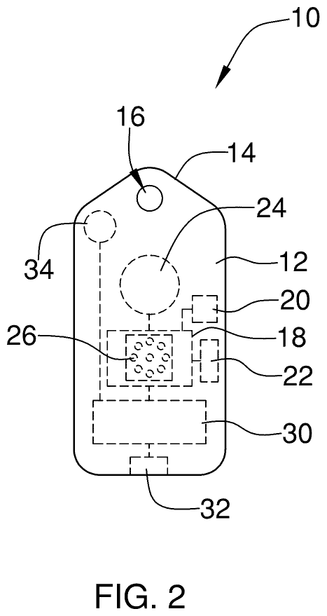

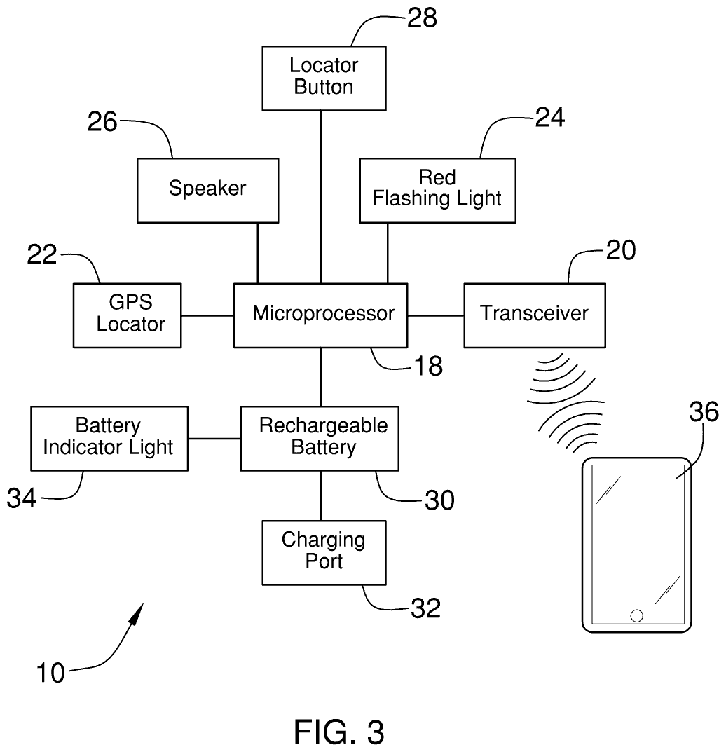

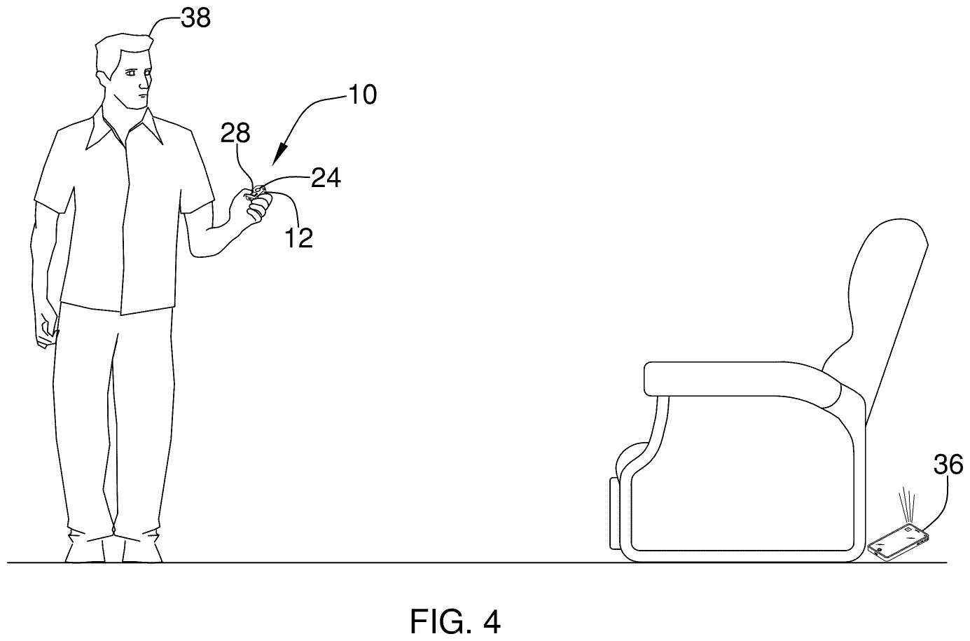

With reference now to the drawings, and in particular to FIGS. 1 through 4 thereof, a new locator device embodying the principles and concepts of an embodiment of the disclosure and generally designated by the reference numeral 10 will be described.

As best illustrated in FIGS. 1 through 4, the locator device 10 generally comprises a housing 12 which comprises a key attachment portion 14 that defines a hole 16 for receiving a keyring. The housing 12 may attach to keys via a clip, clamp, or other suitable fastener. The housing 12 also may be integrally formed with one or more keys in some embodiments. A processor 18 is mounted in the housing 12, and a transceiver 20 is operatively coupled to the processor 18. The processor 18 is configured to communicate wirelessly with a mobile computing device 36, such as a smartphone, a tablet, a computer, or the like via the transceiver 20. The transceiver 20 may follow a Bluetooth protocol, a Wi-Fi protocol, or any other suitable communication protocol.

A Global Positioning System (GPS) module 22 is operatively coupled to the processor 18 and is configured to determine location data for the locator device 10. The processor 18 is programmed to transmit the location data for the locator device 10 to the mobile computing device 36 upon receiving a location request signal from the mobile computing device 36. The mobile computing device 36 may have an application stored in a memory of the mobile computing device 36 so that a user 38 may select to send the location request signal when the user 38 wants to find the locator device 10. The mobile computing device 36 may use another GPS module on the mobile computing device 36 which determines the location of the mobile computing device 36. The mobile computing device 36 may display a map with a route from the mobile computing device 36 to the locator device 10 when the user 38 transmits the location request signal and receives the location data for the locator device 10 such that the user 38 may navigate to the locator device 10.

A locator-finding indicator assembly is operatively coupled to the processor 18 and is configured to alert to a presence of the locator device 10 when a locator alert signal is received from the mobile computing device 36. The device-finding indicator assembly comprises a visual indicator 24 which comprises a light source mounted on the housing 12 and an aural indicator 26 which comprises a speaker mounted in the housing 12. When the locator alert signal is received from the mobile computing device 36, the locator-finding indicator assembly is activated, which may include flashing a light via the light source or sounding an audible alarm via the speaker. Other indication means may be used such as a display screen, a vibration motor, or the like.

A mobile device locator actuator 28 is operatively coupled to the processor 18 and is mounted on the housing 12. The processor 18 is programmed to send a mobile device alert signal to the mobile computing device 36 upon actuation of the mobile device locator actuator 28 to control the mobile computing device 36 to emit an alert. The alert emitted by the mobile computing device 36 may include flashing a light, sounding an audible alarm, vibrating the mobile computing device 36, or the like.

A power supply 30 is electrically coupled to the processor 18. The power supply 30 comprises a battery but may comprise a capacitor or other suitable energy storage. A charging port 32 is electrically coupled to the power supply 30. A charge indicator light source 34 is electrically coupled to the power supply 30 and is activated when the power supply 30 has a sufficient charge for use to power the processor 18.

In use, the locator device 10 may be operated via the mobile computing device 36 to locate the locator device 10 and any keys or other objects attached to the locator device 10. To locate the locator device 10, the mobile computing device 36 may be used to request the location data of the locator device 10 to be sent to the mobile computing device 36 to facilitate the user 38 to navigate to the locator device 10 via a map. Another way to locate the locator device 10 is for the mobile computing device 36 to be actuated to transmit the locator alert signal to activate the locator-finding indicator assembly. In some embodiments, individual indicators may be independently actuatable via the mobile computing device 36. For example, the visual indicator 24 and the aural indicator 26 of the embodiment shown in the Figures may be actuated independently of each other. The mobile computing device 36 may also be found by actuating the mobile device locator actuator 28 to cause the mobile computing device 36 to emit an alert comprising flashing lights, an audible alarm, or another suitable alert perceptible by the user 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A locator device comprising:
a housing;
a processor mounted in the housing;
a transceiver operatively coupled to the processor, the processor being configured to communicate wirelessly with a mobile computing device via the transceiver; and
a Global Positioning System (GPS) module operatively coupled to the processor and configured to determine location data for the locator device, the processor being programmed to transmit the location data for the locator device to the mobile computing device upon receiving a location request signal from the mobile computing device.

2. The device of claim 1, further comprising a locator-finding indicator assembly operatively coupled to the processor, the locator-finding indicator assembly being configured to alert to a presence of the locator device when a locator alert signal is received from the mobile computing device.

3. The device of claim 2, wherein the device-finding indicator assembly comprises a visual indicator comprising a light source mounted on the housing.

4. The device of claim 2, wherein the device-finding indicator assembly comprises an aural indicator comprising a speaker mounted in the housing.

5. The device of claim 1, further comprising a mobile device locator actuator operatively coupled to the processor and mounted on the housing, the processor being programmed to send a mobile device alert signal to the mobile computing device upon actuation of the mobile device locator actuator to control the mobile computing device to emit an alert.

6. The device of claim 1, further comprising a power supply electrically coupled to the processor.

7. The device of claim 6, wherein the power supply comprises a battery.

8. The device of claim 6, further comprising a charging port electrically coupled to the power supply.

9. The device of claim 6, further comprising a charge indicator light source electrically coupled to the power supply, the charge indicator light source being activated when the power supply has a sufficient charge for use to power the processor.

10. The device of claim 1, wherein the housing comprises a key attachment portion configured to attach to a key.

11. The device of claim 10, wherein the key attachment portion defines a hole for receiving a keyring.

12. A locator device comprising:
a housing, the housing comprising a key attachment portion configured to attach to a key, the key attachment portion defining a hole for receiving a keyring;
a processor mounted in the housing;
a transceiver operatively coupled to the processor, the processor being configured to communicate wirelessly with a mobile computing device via the transceiver;
a Global Positioning System (GPS) module operatively coupled to the processor and configured to determine location data for the locator device, the processor being programmed to transmit the location data for the locator device to the mobile computing device upon receiving a location request signal from the mobile computing device;
a locator-finding indicator assembly operatively coupled to the processor, the locator-finding indicator assembly being configured to alert to a presence of the locator device when a locator alert signal is received from the mobile computing device, the device-finding indicator assembly comprising:
a visual indicator comprising a light source mounted on the housing; and
an aural indicator comprising a speaker mounted in the housing;
a mobile device locator actuator operatively coupled to the processor and mounted on the housing, the processor being programmed to send a mobile device alert signal to the mobile computing device upon actuation of the mobile device locator actuator to control the mobile computing device to emit an alert;
a power supply electrically coupled to the processor, the power supply comprising a battery;
a charging port electrically coupled to the power supply; and
a charge indicator light source electrically coupled to the power supply, the charge indicator light source being activated when the power supply has a sufficient charge for use to power the processor.
